(19) United States
(12) Patent Application Publication
(10) Pub. No.: US 2016/0026326 A1
(43) Pub. Date: Jan. 28, 2016

(54) Smart Wearable Device and Computer-Executed Method

(71) Applicants: HannStar Display (Nanjing) Corporation, Nanjing (CN); HANNSTAR DISPLAY CORPORATION, Taipei City (TW)

(72) Inventors: Hsu-Ho WU, Taipei City (TW); Tien-Rong LU, Taipei City (TW)

(21) Appl. No.: 14/791,042

(22) Filed: Jul. 2, 2015

(30) Foreign Application Priority Data
Jul. 25, 2014 (CN) 201410361712.6

(51) Int. Cl. G06F 3/041; G06T 7/00; G06F 17/27; G06F 3/0354; G06F 1/16

(52) U.S. Cl. CPC G06F 3/0416; G06F 3/041; G06F 3/03547; G06F 1/163; G06F 17/271; G06T 7/004; G06F 2203/04101

(57) ABSTRACT

A smart wearable device is capable of detecting a data structure of an electronic data stored therein and generating corresponding link instruction. The smart wearable device comprises a body, a display module and at least one touch-sensing structure. The display module comprises a display unit for displaying information corresponding to the electronic data and a processing unit coupled with the display unit. The touch-sensing structure is coupled with the processing unit and disposed on one side of the display unit, and senses at least one trigger event. The processing unit executes steps comprising: detecting at least one data structure of the electronic data; linking to at least one link instruction corresponding to the detected data structure; enabling the detected data structure to be selected for inputting; and executing the link instruction linked to the selected data structure according to an action received by the touch-sensing structure.

### CROSS REFERENCE TO RELATED APPLICATIONS

This Non-provisional application claims priority under 35 U.S.C. §119(a) on Patent Application No(s). 201410361712.6 filed in People's Republic of China on Jul. 25, 2014, the entire contents of which are hereby incorporated by reference

### BACKGROUND

1. Technical Field

The invention relates to a wearable device, in particular to a smart wearable device.

2. Related Art

With the progress of technologies, various information devices having communication functions are continuously innovated, such as mobile phones, tablet computers, ultra-thin notebook computers, satellite navigation devices or the like. At present, due to advances in technology, the processors are continuously developed to be a smaller size and higher performance. Thus some wearable devices having the sizes much smaller than other communication devices are also developed to have communication functions and other functions.

Accordingly, smart wearable device products, such as smart watches, smart bracelets or the like, have been developed and come out. In comparison with the conventional watch, the smart watch further comprises a positioning module capable of recording a position of the smart watch and a transmission module capable of communicating with other electronic devices to obtain the activity records of the user while wearing the smart watch. Likewise, at present, a kind of bracelet device, the so-called smart bracelet, is also configured with a positioning module and a transmission module.

Although the conventional smart watch or smart bracelet can be inputted by touch, the area for displaying information on the smart watch or the smart bracelet is limited due to small volume. Thus, it is still difficult to perform input operation on the smart watch or the smart bracelet. Because the display area of the smart watch is narrow, it is easily shaded by the user's finger and the inadvertently touch easily occurs. The panel scratching also easily occurs resulting from that the display unit of the smart watch or the smart bracelet is almost touched for input.

Furthermore, the touch display panel often needs to be configured with the rare earth transparent touch-sensing layer such as ITO (indium tin oxide) so as to be kept in high transparent display performance, but since the rare earth metal indium is unceasingly consumed, the cost of the product will be increasingly higher. Besides, the conductivity of the rare earth metal is worse than the normal metal, so that the detection sensitivity of the touch is limited. Therefore, using the rare earth transparent touch-sensing layer in the touch panel is not a good solution for the environmental resources and energy conservation. Moreover, the transparency of the display panel will also be reduced when the ITO transparent touch-sensing layer is formed on the display panel. In addition, even if the ITO is replaced by the metal mesh, the metal interference fringe will influence the readability of the display panel and therefore the performance and convenience of the manual operation will be reduced.

### SUMMARY

An aspect of the invention is to provide a smart wearable device in which the area for touch input is disposed on one side of the display unit. Thus, the screen or objects on the display unit will not be shaded when using and inadvertently touch and panel scratching can be avoided. Moreover, an easy operating method is also provided. By analyzing the data structure of the electronic data and linking to the corresponding instruction to generate corresponding action, the user can straightly operate the device to reduce complexity of operation actions.

A smart wearable device is capable of detecting a data structure of an electronic data stored therein and generating a corresponding link instruction. The smart wearable device comprises a body, a display module and at least one touch-sensing structure. The display module is disposed on the body and comprises a display unit and a processing unit. The display unit displays information corresponding to the electronic data. The processing unit is coupled with the display unit. The touch-sensing structure is coupled with the processing unit and disposed on one side of the display unit, and senses at least one trigger event. The processing unit executes steps comprising: detecting at least one data structure of the electronic data; linking to at least one link instruction corresponding to the detected data structure; enabling the detected data structure to be selected for inputting; and executing the link instruction linked to the selected data structure according to an action received by the touch-sensing structure.

In one embodiment, the processing unit analyzes a grammar of the electronic data, and compares the grammar of the electronic data with a plurality of grammar rules pre-stored in the smart wearable device to detect the data structure of at least one grammar from the electronic data corresponding to the grammar rules.

In one embodiment, the processing unit analyzes a string in the electronic data, and compares the string in the electronic data with a plurality of predefined string patterns pre-stored in the smart wearable device to detect the data structure of at least one string from the electronic data corresponding to the predefined string patterns.

In one embodiment, contents of the link instruction are displayed on the display unit in a menu form.

In one embodiment, the smart wearable device comprises two touch-sensing structures separately disposed on two opposite sides of the display unit.

In one embodiment, the trigger event comprises a trigger quantity, a trigger quantity distribution, a trigger morphology, a trigger time, a trigger frequency, or a trigger location.

In one embodiment, the touch-sensing structure is a capacitive touch-sensing structure.

In one embodiment, the smart wearable device further comprises at least one function unit disposed on the body or the touch-sensing structure and coupled with the processing unit. The function unit comprises a wireless transmission unit, a wireless communication unit or a wireless charging unit.

In one embodiment, the wireless transmission unit comprises an infrared module, a Bluetooth module, a ZigBee module, a radio frequency module or a near field communication module.

In one embodiment, the wireless communication unit comprises a wireless communication chip and an antenna, the wireless communication chip is electrically connected with the processing unit, and the antenna is disposed on the body or the touch-sensing structure.

In one embodiment, one end of the body comprises a signal port for data transmission or power transmission.

In one embodiment, the touch-sensing structure comprises a driving circuit and a sensing circuit, the driving circuit is disposed inside the body, and the sensing circuit is disposed on an outer surface of the body.

In one embodiment, a part of the sensing circuit forms a protrusion on the outer surface of the body, and the body further comprises a protection layer covering the protrusion.

In one embodiment, the touch-sensing structure comprises a transparent conducting film, metal nanowires, graphene, carbon nanotube, or a metal mesh.

A computer-executed method is capable of detecting a data structure of an electronic data and generating a corresponding link instruction, and executed on a smart wearable device. The smart wearable device comprises a display module and a touch-sensing structure, and the touch-sensing structure is disposed on one side of the display module. The method comprises: detecting at least one data structure of the electronic data; linking to at least one link instruction corresponding to the detected data structure; enabling the detected data structure to be selected for inputting; and executing the link instruction linked to the selected data structure according to an action received by the touch-sensing structure.

In one embodiment, the steps of detecting comprises: analyzing a grammar of the electronic data; comparing the grammar of the electronic data with a plurality of grammar rules pre-stored in the smart wearable device; and detecting the data structure of at least one grammar from the electronic data corresponding to the grammar rules.

In one embodiment, the detected data structure corresponding to the grammar rules is linked to the link instruction.

In one embodiment, the steps of detecting comprises: analyzing a string in the electronic data; comparing the string in the electronic data with a plurality of predefined string patterns pre-stored in the smart wearable device; and detecting the data structure of at least one string from the electronic data corresponding to the predefined string patterns.

In one embodiment, the method further comprises: marking the information of the detected data structure displayed on the display unit.

In one embodiment, the step of enabling comprises: displaying contents of the link instruction on the display unit in a menu form.

As mentioned above, as to the smart wearable device, because the touch-sensing structures for touch input by user are separately disposed on the two opposite sides of the display module, the finger will not shade the user's view and the screen displayed on the display module so as to decrease inadvertent touch. Moreover, because the smart wearable device is operated on the touch-sensing structure, the panel scratching can be decreased. In addition, because the element of performing the touch operation is the touch-sensing structure, the conventional physical button can be replaced, and the overall integrity and beauty of the outlook of the smart wearable device can be enhanced, and higher quality and more wonderful user experience can be implemented.

As to the touch-sensing structure of the smart wearable device and the computer-executed method executed by the processing unit, the user can operate the user interface displayed by the display unit on the touch-sensing structure. The method comprises: detecting at least one data structure of the electronic data; linking to at least one link instruction corresponding to the detected data structure; enabling the detected data structure to be selected for inputting; and executing the link instruction linked to the selected data structure according to an action received by the touch-sensing structure. The data structure detected as having the specific grammar rule or string pattern. The user can directly select the electronic data having the specific grammar rule or string pattern, and then the processing unit can correspondingly execute the instruction for the specific grammar rule or string pattern. Thus, the operation procedure for the user is simplified and it is more convenient for the user to operate. Moreover, because the user can touch the touch-sensing structure disposed on one side of the display unit, the finger will not shade the objects on the screen or the information shown on the display module, and will not inadvertently touch even open an undesired link (linking to the corresponding instruction) due to a high information density content.

### BRIEF DESCRIPTION OF THE DRAWINGS

The embodiments will become more fully understood from the detailed description and accompanying drawings, which are given for illustration only, and thus are not limitative of the present invention, and wherein:

FIG. 1A is a schematic diagram showing a smart wearable device according to one embodiment of the invention;

FIG. 1B is a schematic diagram showing a smart wearable device according to another embodiment of the invention;

FIG. 2 is a function block diagram of the display module and the touch-sensing structures shown in FIG. 1B;

FIG. 3 is a schematic diagram showing the operation of the smart wearable device in FIG. 1B;

FIG. 4 is a schematic flowchart of the computer-executed method according to one embodiment of the invention;

FIG. 5A to FIG. 5E are schematic diagrams showing the user interface of the smart wearable device in FIG. 1B;

FIG. 6 is a schematic diagram showing the user interface of the smart wearable device according to another example in FIG. 1B;

FIG. 7 is a schematic diagram showing a smart wearable device according to an additional embodiment of the invention; and

FIG. 8 is a schematic diagram showing a smart wearable device according to an additional embodiment of the invention.

### DETAILED DESCRIPTION OF THE INVENTION

The embodiments of the invention will be apparent from the following detailed description, which proceeds with reference to the accompanying drawings, wherein the same references relate to the same elements.

The smart wearable device of this embodiment refers to the device that the user can directly wear, such as a smart bracelet or a smart watch. The smart wearable device of this embodiment also can be a detachable wearable device, such as a device worn in the form of a necklace. However, it is not limited thereto. Therefore, the smart wearable device of this embodiment also refers to the small-sized electronic device having the display function and interaction function. The smart wearable devices of the following embodiments are described with the smart watch serving as examples.

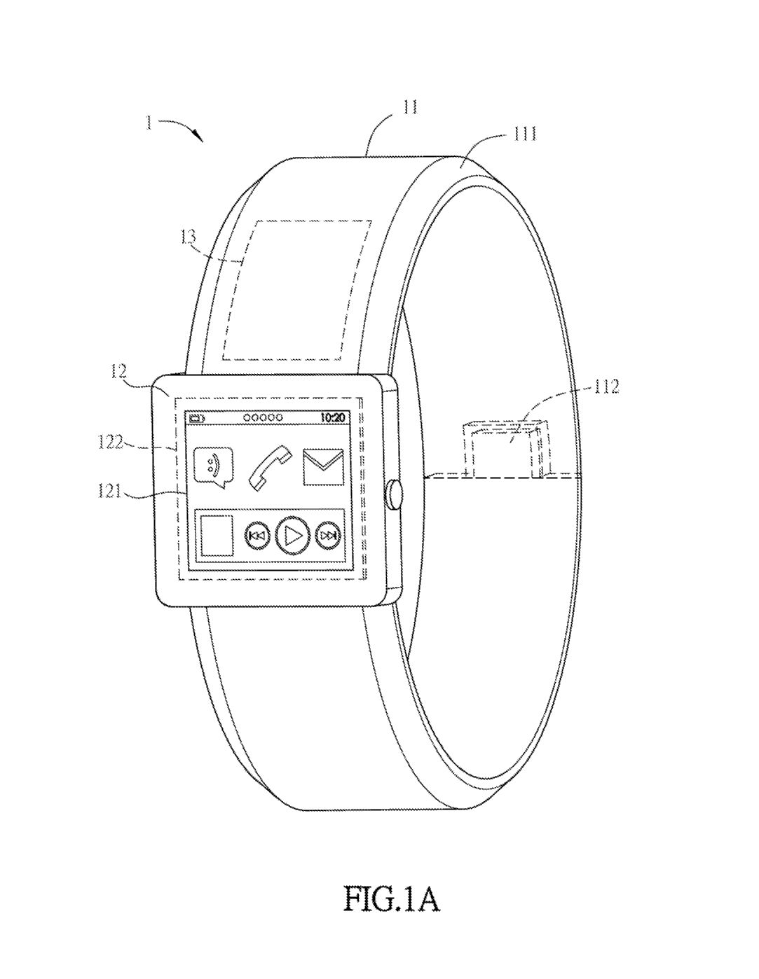

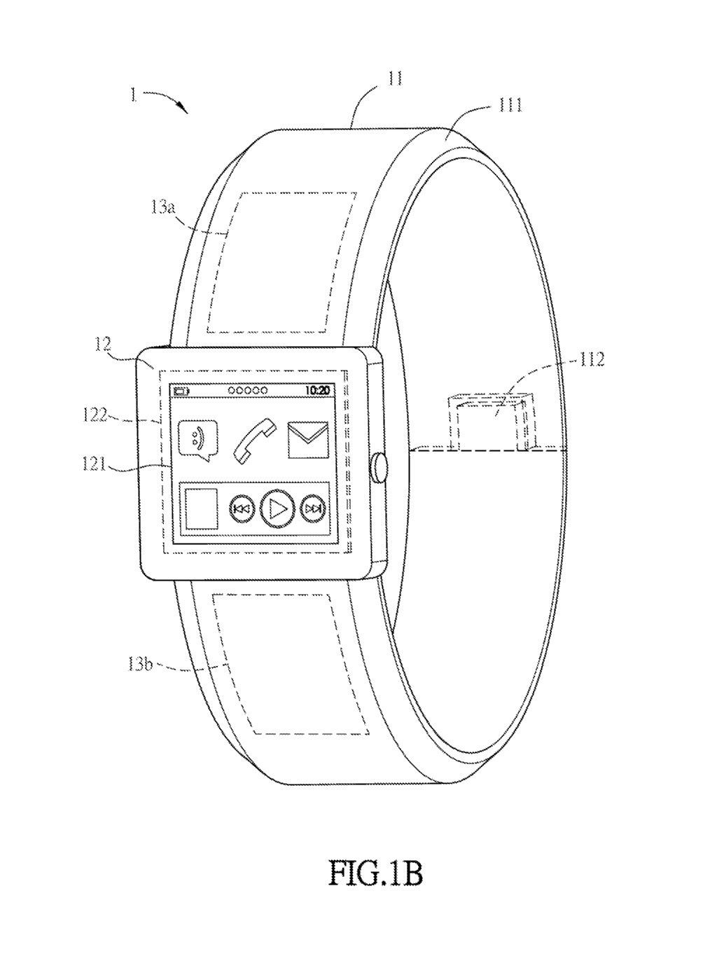

Referring to FIG. 1A, FIG. 1A is a schematic diagram showing a smart wearable device according to one embodiment of the invention. The smart wearable device 1 of this embodiment is a smart watch to be described as an example. In addition, the elements of the smart wearable device 1 of this embodiment may be implemented by the combination of the hardware, software or firmware of one or multiple signal processing and/or integrated circuits.

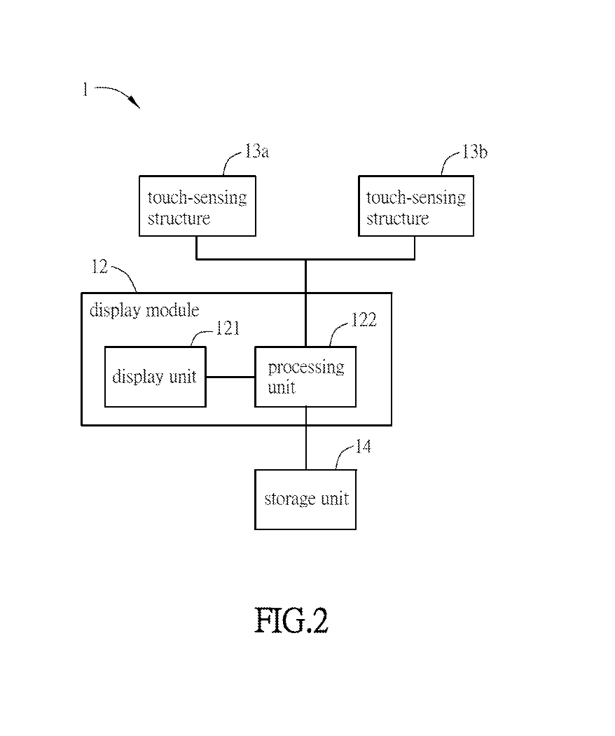

The smart wearable device 1 of this embodiment comprises a body 11, a display module 12 and at least one touch-sensing structure 13. FIG. 1B is a schematic diagram showing a smart wearable device according to another embodiment of the invention. The smart wearable device 1 comprises two touch-sensing structures 13a and 13b. The following embodiment is based on the two touch-sensing structures 13a and 13b as an example. The body 11 is the portion that the user can wear and is a watchband or a strap in this embodiment, and can be of a watch bracelet or a necklace chain in other embodiments. However, this invention is not limited thereto. The display module 12 is disposed on the body 11 and comprises a display unit 121 and a processing unit 122. As shown in FIG. 2, FIG. 2 is a function block diagram of the display module and the touch-sensing structures shown in FIG. 1B. The processing unit 122 is coupled with the display unit 121 to control the information and image displayed by the display unit 121. In this embodiment, in addition to a normal image of showing the time, the display unit 121 also can provide a graphical user interface (GUI) for the user. The graphical user interface can comprise one or multiple figures to exhibit any kind of the known software objects in the form of a figure (such as an icon). The display unit 121 is, for example but not limited to, a liquid crystal display (LCD) device, a light-emitting diode (LED) display device, an organic light-emitting diode (OLED) display device or an electronic paper (electrophoretic display device). The display unit 121 of this embodiment can be a trans-reflective LCD device, and its advantage is that the display unit 121 can maintain the sunlight readability under the sunlight or a strong light, which means the image displayed by the display unit 121 is still visible clearly under the strong light. Besides, when the light is sufficient, the additional illustration can be provided by reflecting the surrounding light of the smart wearable device 1, so as to save energy.

As shown in FIG. 1B, the touch-sensing structures 13a and 13b are disposed on a side of the display unit 121. The touch-sensing structures 13a and 13b are separately disposed on the two opposite sides of the display unit 121. In this embodiment, the touch-sensing structures 13a and 13b are respectively disposed on the upper side and lower side of the display unit 121. In other embodiments, the touch-sensing structures 13a and 13b can be respectively disposed on edges 111 of the body 11 to form the embodiment where the touch-sensing structures 13a and 13b are disposed on the left side and right side of the display unit 121. On the other hand, the touch-sensing structures 13a and 13b can be disposed on the upper side, lower side, left side and right side of the display unit 121 so as to increase the area for the user's operation. However, this invention is not limited thereto. In this embodiment, the touch-sensing structures 13a and 13b of this embodiment are capacitive touch-sensing structures. When a conductor (such as the user's finger) touches the touch-sensing structures 13a and 13b, a capacitance variation appears at the touch position of the touch-sensing structures 13a and 13b and the corresponding signal can be thus generated. Moreover, the advantage of providing the touch-sensing structures 13a and 13b separately disposed on the two opposite sides of the display unit 121 for the user's touch operation comprises that the touch-sensing structures 13a and 13b needn't be made by the transparent touch-sensing material (such as ITO) for matching the display performance of the display unit 121, and therefore the material selection will be more flexible and the cost can be easily controlled. Besides, the touch-sensing structures 13a and 13b can comprise a driving circuit and a sensing circuit (i.e. the so-called Tx and Rx, not shown), and the material thereof can be a conducting layer (such as a transparent conducting layer, comprising indium tin oxide (ITO), indium zinc oxide (IZO), fluorine-doped tin oxide (FTO), Al-doped ZnO, Ga-doped ZnO for example), metal nanowires, graphene, carbon nanotube or a metal mesh, but this invention is not limited thereto

In one embodiment, the driving circuit is disposed inside the body 11, the sensing circuit is disposed on the outer surface of the body 11 and a part of the sensing circuit forms a protrusion on the outer surface of the body 11. The body 11 can further comprise a protection layer covering the protrusion to protect the sensing circuit. The user can know the locations of the touch-sensing structures 13a and 13b by touching the protrusion. In other words, by the sensing circuit of the protrusion, the locations of the touch-sensing structures 13a and 13b can be indicated. In other embodiments, the protrusion can be designed into a certain shape such as an arrowhead and also can be used to indicate the user while inputting touch operation.

As shown in FIG. 2, the smart wearable device 1 can further comprise a storage unit 14 acting as the storing medium of the smart wearable device 1. The storage unit 14 also can be the memory inside the smart wearable device 1 or outside the smart wearable device 1 (such as the cloud memory or cloud storage), but this invention is not limited thereto. The storage unit 14 can store the operation system, application programs, data processing programs and electronic data of various formats. The operation system is the program managing the computer hardware and software resources. The application program can be a word processing program, email program or others. In this embodiment, the storage unit 14 is coupled with the processing unit 122, and the processing unit 122 comprises a central processing unit (CPU) for example to execute the programs.

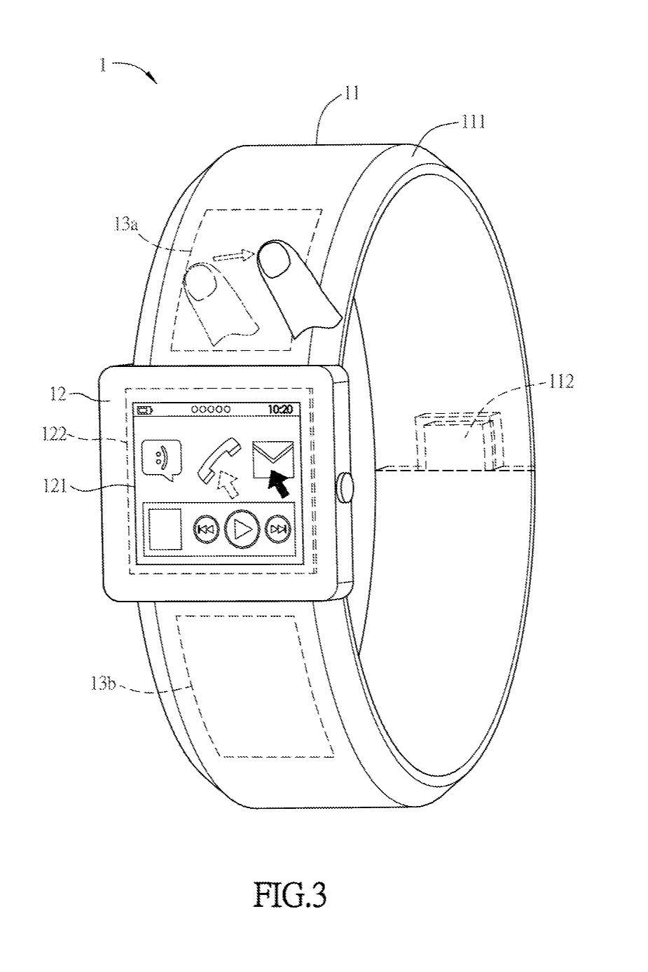

The touch-sensing structures 13a and 13b are coupled with the processing unit 122. Thereby, the user can execute the touch operation on the touch-sensing structures 13a and 13b by finger for example, and the display unit 121 can display the corresponding operation according to the user's operation gesture (or called the hand gesture), and thereby the user can interact with the graphical user interface displayed on the display unit 121. For example, when the user's finger slides on the touch-sensing structures 13a and 13b, the display unit 121 will display a corresponding icon (such as an arrow or hand shape) while sliding correspondingly. Referring to FIG. 3, FIG. 3 is a schematic diagram showing the operation of the smart wearable device in FIG. 1B. Moreover, the interaction with the graphical user interface can be, for example, that the user touches the touch-sensing structures 13a and 13b by the finger to execute the click, enlargement or movement. For example, when the user's finger taps the touch-sensing structures 13a and 13b, the display unit 121 will execute the item which corresponds to the position information. Thereby, the item displayed by the display unit 121 can be directly controlled and executed through the touch-sensing structures 13a and 13b, so the shadeless touch can be achieved. The above-mentioned touch can comprise, for example, an operation gesture or hand gesture, such as a single tap or multiple taps, a single slide or multiple slides (such as a rightward, leftward, upward or downward slide), sequential clicks by multiple fingers, or simultaneous slide by multiple fingers.

Physically, each touch action can make the touch-sensing structures 13a and 13b sense at least one trigger event, and the signal induced by the trigger event is transmitted to the processing unit 122, so that the processing unit 122 can execute the analysis and process to generate a corresponding operation, such as executing an action. The processing unit 122 of this embodiment can be composed of a single processing chip or multiple processing chips, and can not only control the content displayed by the display unit 121 but also analyze the trigger event sensed by the touch-sensing structures 13a and 13b. The trigger event comprises a trigger quantity, a trigger quantity distribution, a trigger morphology (which can refer to trigger appearance), a trigger time or a trigger frequency. Besides, the actions of the smart wearable device 1 in response to various trigger events can be determined by factory settings and/or according to the user's personal usage preference.

The processing unit 122 can execute the action according to the trigger time, trigger path or trigger frequency of the trigger event. The trigger time refers to the time period for which the user's finger touches the touch-sensing structures 13a and 13b. For example, a shorter click (which refers to a shorter trigger time) refers to the execution of the operation and a longer click (which refers to a longer trigger time) refers to the confirmation of the operation. The trigger path refers to the path along which the touch action is executed, and a certain path can be set to execute the corresponding action. The trigger frequency refers to the frequency of the touch action in a short time, and that is the frequency with which the user clicks the touch-sensing structures 13a and 13b, and a certain click frequency can be set to correspond to an action.

As mentioned hereinabove, the touch-sensing structures 13a, 13b are separately disposed on two opposite sides of the display unit 121 to avoid that the user's hand shade the screen on the display unit 121 and inadvertent touch while wearing the smart wearable device 1. The computer-executed method of this embodiment is executed in the smart wearable device 1 having the touch-sensing structures 13a, 13b respectively disposed on two opposite sides of the display unit 12. The computer-executed method of this embodiment is for detecting the electronic data stored in the smart wearable device 1 and generating the corresponding link instruction, and is implemented in the smart wearable device 1.

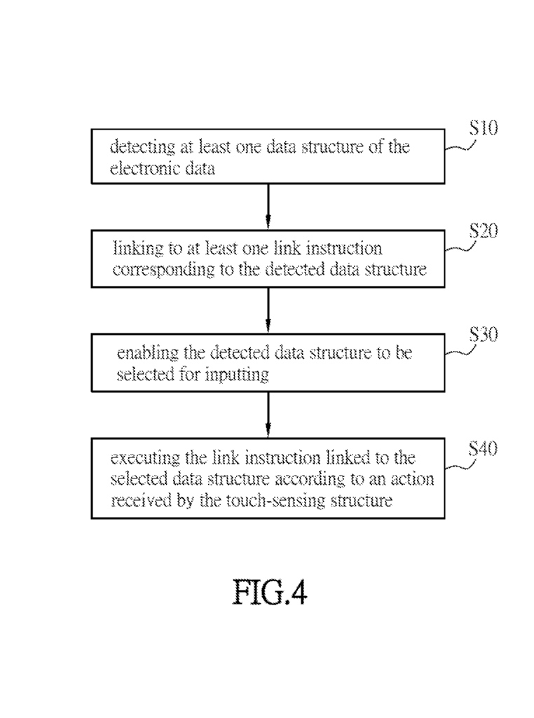

FIG. 4 is a schematic flowchart of the computer-executed method according to one embodiment of the invention. Referring to FIG. 4, the computer-executed method of the embodiment is capable of detecting a data structure of an electronic data and generating a corresponding link instruction, and it executes the following steps on the smart wearable device: detecting at least one data structure of the electronic data (step S10); linking to at least one link instruction corresponding to the detected data structure (step S20); enabling the detected data structure to be selected for inputting (step S30); and executing the link instruction linked to the selected data structure according to an action received by the touch-sensing structure (step S40).

For example, the smart wearable device 1 can execute application programs for example an e-mail program or a text editing program. In the embodiment an e-mail program is executed for example. When the user clicks or selects the content of one e-mail or one document therein, the corresponding e-mail or document is transmitted in a form of electronic data to the processing unit 122. Then, the processing unit 122 executes the method of the embodiment (step S10 to step S40). In step S10, when the user wears the smart wearable device 1, the processing unit 122 can detect the data structure of the document content currently displayed on the display unit 121.

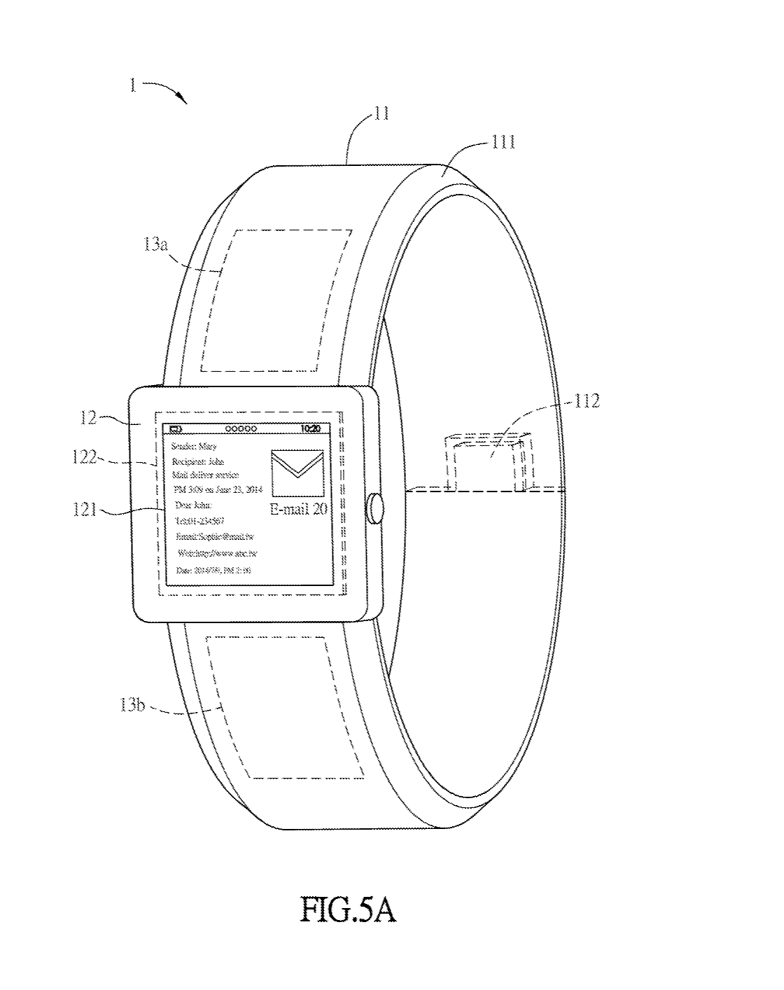

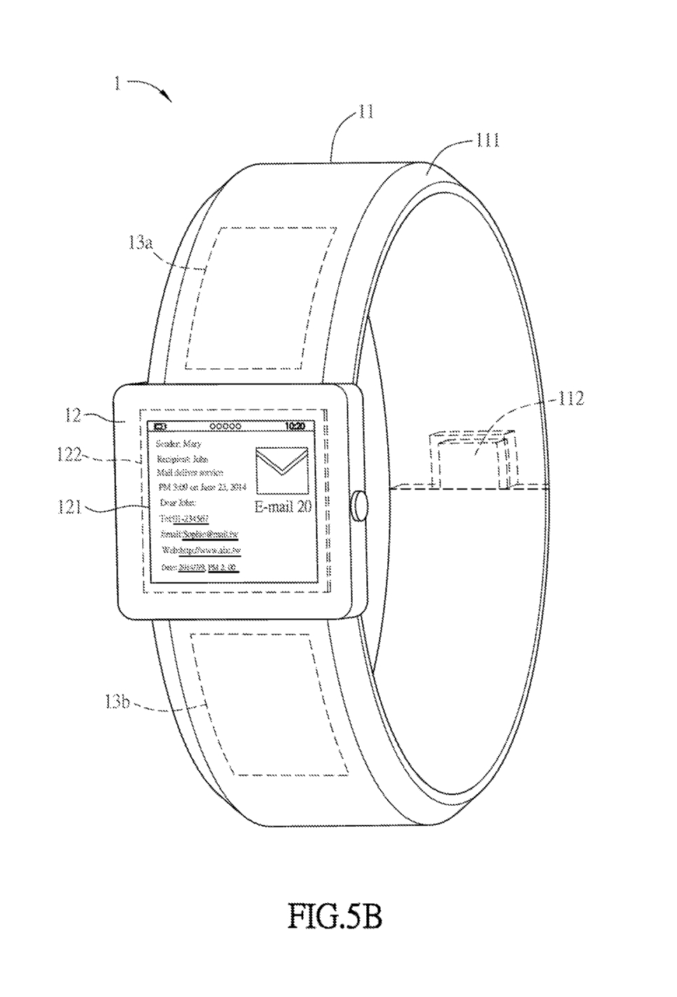

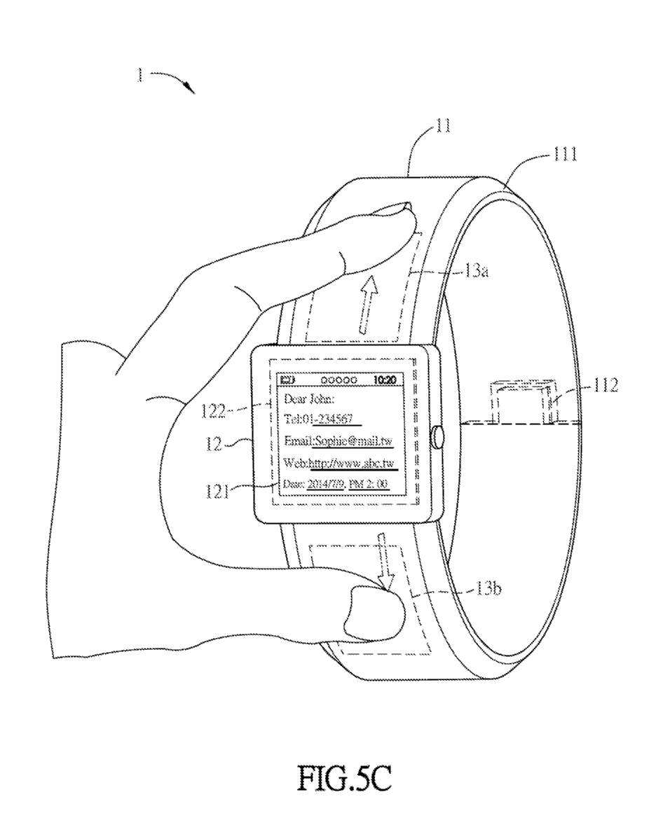

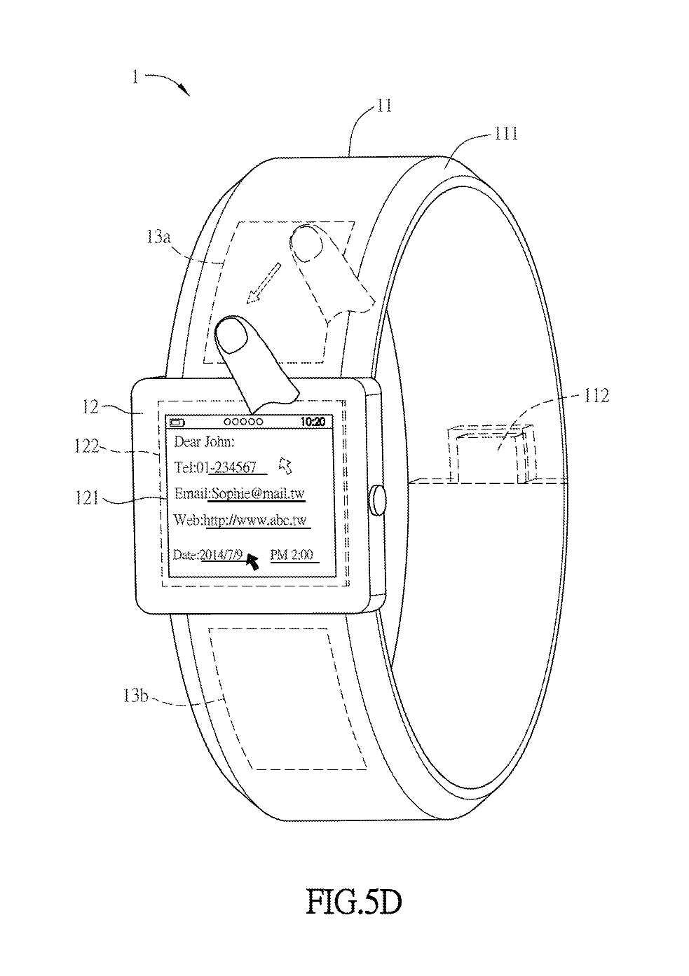

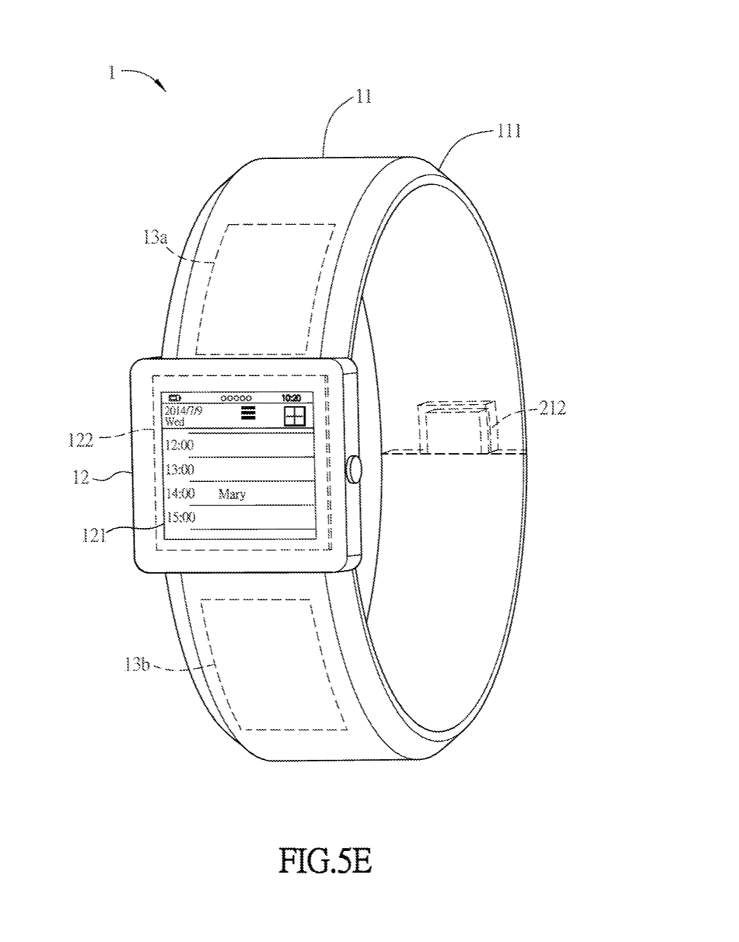

Descriptions will be continued according to the user interface displayed by the smart wearable device 1. FIG. 5A to FIG. 5E are schematic diagrams showing the user interface of the smart wearable device in FIG. 1B. Referring to FIG. 5A, the display panel 121 displays the information corresponding to the electronic data (the contents of the e-mail in this embodiment). Referring to FIG. 2 and FIG. 4, at least one data structure of electronic data is detected in step S10, and the processing unit 122 can analyze the grammar or string of the electronic data and compare the grammar or string of the electronic data with the grammar rules or predetermined string patterns pre-stored in the hand-held electronic device to detect the data structure of the electronic data having multiple grammars or multiple strings. In details, the storage unit 14 stores a grammar rule file and a string library, the grammar rule file has the grammars, and the string library has the predetermined string patterns. In addition, the storage unit 14 concurrently stores the corresponding link instruction corresponding to each grammar rule and each predetermined string pattern.

After the processing unit 122 receiving the electronic data (the document of the e-mail), the electronic data in the grammar rule may be compared, and the data structure having the specific grammar rule may be screened from the electronic data. In this embodiment, the data structure may also be referred to as the detected data structure, that is, the data structure detected as having the specific grammar rule or predetermined string pattern. The specific grammar rule of this embodiment comprises a telephone number, an address, an e-mail address, a uniform resource location (URL) or the similar grammar. Then, the detected data structure having the specific grammar rule is linked to the corresponding link instruction (step S20), so that the corresponding operation is generated. In addition, the search or comparison can be performed on the contents of the electronic data in the string library by the string searching function to screen the data structure having the predetermined string pattern, and the predetermined string pattern may also be the telephone number, address, date or time or the similar string pattern. For example, if the data structure having the grammar or string pattern of the telephone number is detected, then it can be linked to the link instruction of executing the phonebook application program. If the data structure having the address grammar is detected, then it can be linked to the link instruction of executing the electronic map application program. If the data structure having the date or time string pattern is detected, then it can be linked to the link instruction of executing the calendar application program.

Next, in step 30, the processing unit 122 can enable the detected data structure to be selected for inputting. In this embodiment, the processing unit 122 can enable a portion of the touch-sensing structure 13a or the touch-sensing structure 13b corresponding to the detected data structure to be selected for inputting. In other embodiments, the position to be selected for inputting is not particularly restricted. In details, the processing unit 122 can mark the pointer corresponding to the detected data structure having the specific grammar rule or predetermined string pattern in the data of the real-time displayed on the display unit 121, and correspondingly transmit the data of the associated position to the display unit 121 and the touch-sensing structures 13a, 13b. Thus, the information (i.e., telephone number, e-mail address, URL, address, date, time) of the detected data structure displayed on the display unit 121 is marked, as shown in FIG. 5B. As shown in FIG. 5C, after executing the instruction of enlarging the screen, the user can further touch the touch-sensing structure 13a or the touch-sensing structure 13b corresponding to the marked region for user's input as shown in FIG. 5D. In other words, the data structure detected as having the specific grammar or string can form a link, so that the user can touch the link on the touch-sensing structures 13a, 13b, and thus select the data structure having the specific grammar or string for input. In this embodiment, the touch input is performed in the region of the touch-sensing structures 13a, 13b corresponding to the date and time for example.

In details, in step S40, the user can perform the input on the touch-sensing structures 13a, 13b. In this embodiment, the position of the input is the touch-sensing structures 13a, 13b corresponding to the detected data structure. Meantime, the touch-sensing structures 13a, 13b are triggered to generate the trigger event, which is transmitted to the processing unit 122. As mentioned hereinabove, the trigger event may be the trigger quantity, the trigger quantity distribution, the trigger morphology, the trigger time, the trigger frequency or the trigger location. In this embodiment, the trigger quantity is described as an example. In this embodiment, the processing unit 122 can compute the trigger quantity of the detection points of the touch-sensing structures 13a, 13b triggered by the input. When the trigger quantity falls within a predetermined range, this condition may be defined as the meaningful input. The processing unit 12 can execute the link instruction linked to the selected data structure according to the input. The predetermined range may be defined as the range of the trigger quantity generated when the user's preferred finger operates to trigger the detection point of the touch-sensing structures 13a, 13b. This approach can decrease the problem that other conductors inadvertently touch the touch-sensing structures.

As shown in FIG. 5D, this embodiment is described in an example of selecting the data structure having the date grammar or string, and the instruction linked to the data structure having the date grammar or string is an instruction of executing the calendar application program. Thus, when the user touches the position corresponding to the telephone number on the touch-sensing structures 13a, 13b, the cursor may be displayed at the position around the date displayed on the display unit 121, and the date is selected for inputting. Meanwhile, the data structure having the date grammar or string is selected, and the processing unit 121 executes the instruction of the calendar application program so that the user can write the schedule content on the calendar as shown in FIG. 5E.

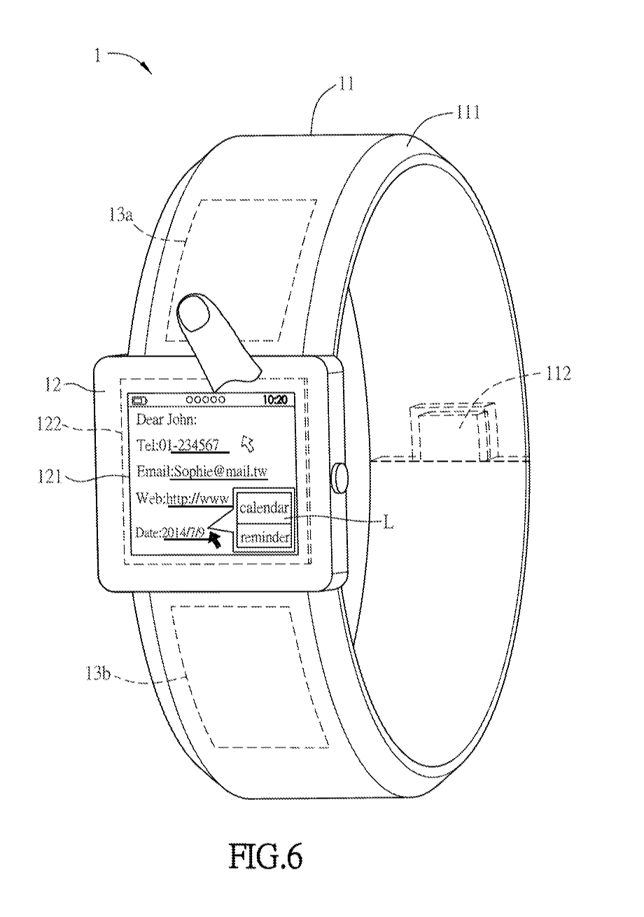

In another embodiment, the detected data structure to be selected is enabled for inputting (step S30), which may also be implemented by displaying the link instruction in a menu form. FIG. 6 is a schematic diagram showing the user interface of the smart wearable device according to another example in FIG. 1B. As shown in FIG. 6, a menu L is displayed at the position showing the date on the display unit 121. The menu L shows multiple option icons of multiple instruction contents, such as “calendar (instruction)” and “reminder (instruction)” option icons, so that the user can further tap the subsequent operation. The user can similarly perform touch input at the position corresponding to the option icon on the touch-sensing structures 13a, 13b. In other words, the detected data structure may be linked to multiple instructions. If the user taps the “calendar (instruction)” option icon, then the processing unit 122 executes the instruction of the calendar application program as mentioned above. If the user taps the “reminder (instruction)” option icon, then the processing unit 122 directly stores the instruction of executing reminder on the date, for example reminder by alarm clock or vibration.

Referring to FIG. 1B, one end of the body 11 has a signal port 112, which is coupled to the processing unit 122 and can be used for power transmission or data transmission. The information stored in the smart wearable device 1 can be transmitted to other electronic devices. In other embodiments, wireless functions can be utilized to perform wireless charging or wireless data transmission, which is not limited thereto.

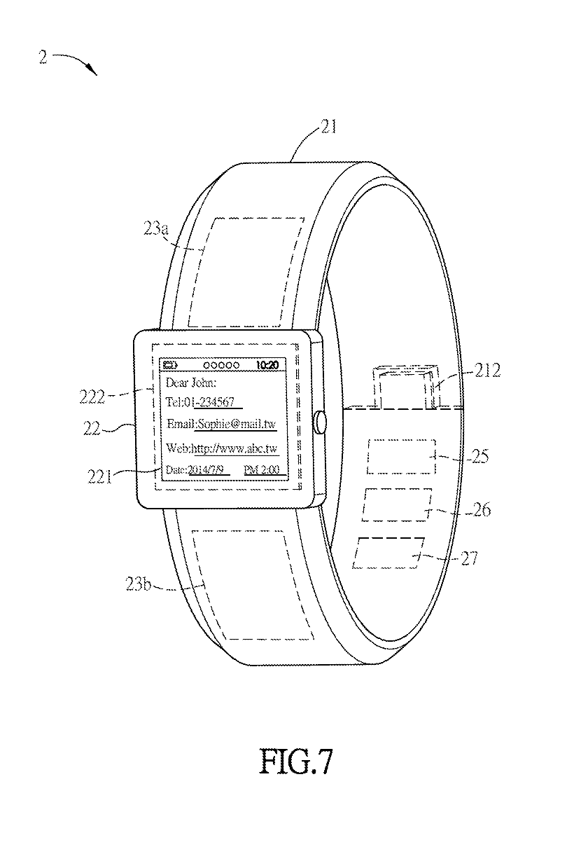

FIG. 7 is a schematic diagram showing a smart wearable device 2 according to an additional embodiment of the invention. Referring to FIG. 7, in one embodiment, the smart wearable device 2 further comprises at least one function unit disposed on the body 21 or the touch-sensing structures 23a, 23b and coupled to the processing unit 222. The function unit comprises at least one of the wireless transmission unit 25, the wireless communication unit 26 and the wireless charging unit 27.

Moreover, the wireless transmission unit 25 comprises an infrared module, a Bluetooth module, a ZigBee module, a radio frequency module or a near-field communication (NFC) module. The wireless transmission unit 25 is a NFC module for example. The NFC module comprises a NFC chip and an antenna. The NFC chip is electrically connected to the processing unit 222, the antenna is disposed on the touch-sensing structure 23a and/or the touch-sensing structure 23b, and they are not limited thereto. When the user want to utilize the smart wearable device 2 to perform NFC with another electronic device, he can take the smart wearable device 2 close to another electronic device having NFC function so as to transmit electronic data through the antenna and the NFC chip. The structure of the wireless communication unit 26 is similar to that of the wireless transmission unit 25, the wireless communication unit 26 has wireless communication chip and antenna, the wireless communication chip is coupled with the processing unit 222 and the antenna is disposed on the touch-sensing structure 23a and/or the touch-sensing structure 23b. The wireless transmission unit 25 is applied to data transmission of short distance with other electronic devices. The wireless communication unit 26 is applied to data transmission through the telecommunication or network signals. In other embodiments, a combination of the function unit may synchronously or asynchronously transmit a wireless signal and receive a wireless charging energy from a wireless charging device. The wireless charging energy may come from a wireless access point, a display, a television or a monitor, etc.

The wireless charging unit 27 may be a charging circuit and is disposed on the body 21 for wireless charging. In other embodiments, the wireless charging unit 27 may also be disposed on the touch-sensing structure 23a, 23b. In details, if the touch-sensing structure 23a, 23b comprises a metal mesh, metal nanowires, carbon nanotube or the graphene, the driving circuit and the sensing circuit of the touch-sensing structure 23a, 23b may further be adopted to perform the wireless power transmission, such as wireless charging.

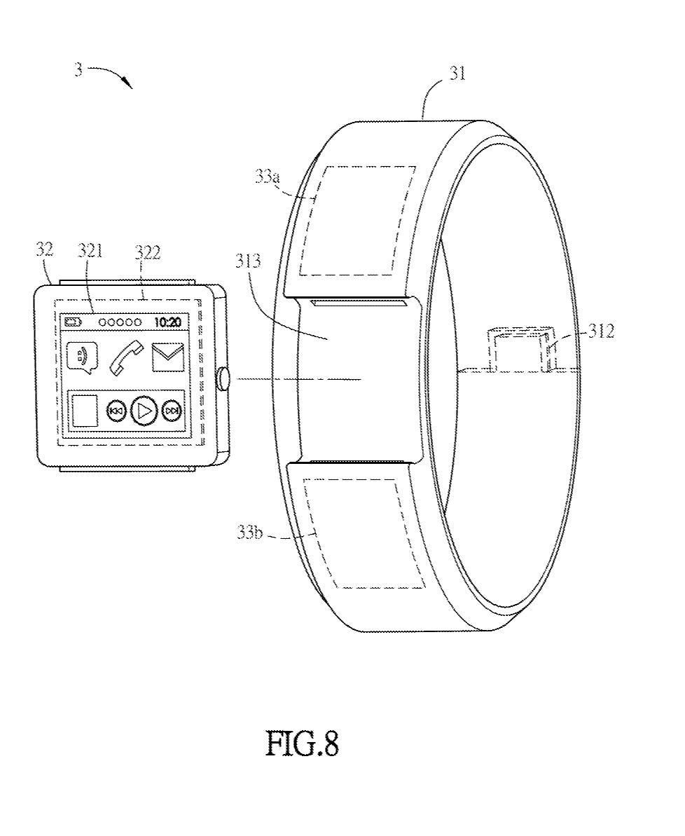

Moreover, the disposition of the display module is not limited. In other embodiments, the display module may be detachably disposed on the body. Referring to FIG. 8, FIG. 8 is a schematic diagram showing a smart wearable device according to an additional embodiment of the invention. In the embodiment. The body 31 further comprises a slot for accommodating the display module 32.

In other embodiments, the smart wearable device can be applied to smart bracelet or smart remote controller. Other electronic device having display unit can be controlled by the smart wearable device (smart remote controller). In other words, touching the touch-sensing structure can perform input and select link instruction on other electronic device.

A computer-executed method is provided and capable of detecting a data structure of an electronic data and generating a corresponding link instruction, and executed on a smart wearable device. The smart wearable device comprises a display module and a touch-sensing structure, and the touch-sensing structure is disposed on one side of the display module. The method comprises: detecting at least one data structure of the electronic data; linking to at least one link instruction corresponding to the detected data structure; enabling the detected data structure to be selected for inputting; and executing the link instruction linked to the selected data structure according to an action received by the touch-sensing structure.

As mentioned above, as to the smart wearable device, because the touch-sensing structures for touch input by user are separately disposed on the two opposite sides of the display module, the finger will not shade the user's view and the screen displayed on the display module, so that inadvertent touch will decrease. Moreover, because the smart wearable device is operated on the touch-sensing structure, the panel scratching can be decreased. In addition, because the element of performing the touch operation is the touch-sensing structure, the conventional physical button can be replaced, and the overall integrity and beauty of the outlook of the smart wearable device can be enhanced, and higher quality and more wonderful user experience can be implemented.

As to the touch-sensing structure of the smart wearable device and the computer-executed method executed by the processing unit, the user can operate the user interface displayed by the display unit on the touch-sensing structure. Which method comprise: detecting at least one data structure of the electronic data; linking to at least one link instruction corresponding to the detected data structure; enabling the detected data structure to be selected for inputting; and executing the link instruction linked to the selected data structure according to an action received by the touch-sensing structure. The data structure detected as having the specific grammar rule or string pattern. The user can directly select the electronic data having the specific grammar rule or string pattern, and then the processing unit can correspondingly execute the instruction for the specific grammar rule or string pattern. Thus, the operation procedure for the user is simplified and it is more convenient for user's operation. Moreover, because the user can touch the touch-sensing structure disposed on one side of the display unit, the finger will not shade the objects on the screen or the information shown on the display module. The user will neither inadvertently touch nor open an undesired link (linking to the corresponding instruction) in a high information density content.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A smart wearable device, capable of detecting a data structure of an electronic data stored therein and generating a corresponding link instruction, comprising:
a body;
a display module, disposed on the body and comprising:
a display unit, displaying an information corresponding to the electronic data; and
a processing unit, coupled with the display unit; and
at least one touch-sensing structure, coupled with the processing unit, disposed on one side of the display unit and sensing at least one trigger event,
wherein the processing unit executes steps comprising:
detecting at least one data structure of the electronic data;
linking to at least one link instruction corresponding to the detected data structure;
enabling the detected data structure to be selected for inputting; and
executing the link instruction linked to the selected data structure according to an action received by the touch-sensing structure.

2. The smart wearable device of claim 1, wherein the processing unit analyzes a grammar of the electronic data, and compares the grammar of the electronic data with a plurality of grammar rules pre-stored in the smart wearable device to detect the data structure of at least one grammar from the electronic data corresponding to the grammar rules.

3. The smart wearable device of claim 1, wherein the processing unit analyzes a string in the electronic data, and compares the string in the electronic data with a plurality of predefined string patterns pre-stored in the smart wearable device to detect the data structure of at least one string from the electronic data corresponding to the predefined string patterns.

4. The smart wearable device of claim 1, wherein contents of the link instruction are displayed on the display unit in a menu form.

5. The smart wearable device of claim 1, wherein two touch-sensing structures separately disposed on two opposite sides of the display unit.

6. The smart wearable device of claim 1, wherein the trigger event comprises a trigger quantity, a trigger quantity distribution, a trigger morphology, a trigger time, a trigger frequency, or a trigger location.

7. The smart wearable device of claim 1, wherein the touch-sensing structure is a capacitive touch-sensing structure.

8. The smart wearable device of claim 1, further comprising:
at least one function unit, disposed on the body or the touch-sensing structure and coupled with the processing unit, and comprising a wireless transmission unit, a wireless communication unit or a wireless charging unit.

9. The smart wearable device of claim 8, wherein the wireless transmission unit comprises an infrared module, a Bluetooth module, a ZigBee module, a radio frequency module or a near field communication module.

10. The smart wearable device of claim 8, wherein the wireless communication unit comprises a wireless communication chip and an antenna, the wireless communication chip is electrically connected with the processing unit, and the antenna is disposed on the body or the touch-sensing structure.

11. The smart wearable device of claim 1, wherein one end of the body comprises a signal port for data transmission or power transmission.

12. The smart wearable device of claim 1, wherein the touch-sensing structure comprises a driving circuit and a sensing circuit, the driving circuit is disposed on an inner part of the body, and the sensing circuit is disposed on an outer surface of the body.

13. The smart wearable device of claim 12, wherein a part of the sensing circuit forms a protrusion on the outer surface of the body, and the body further comprises a protection layer covering the protrusion.

14. The smart wearable device of claim 1, wherein the touch-sensing structure comprises a transparent conducting film, metal nanowires, graphene, carbon nanotube or a metal mesh.

15. A computer-executed method capable of detecting a data structure of an electronic data and generating a corresponding link instruction, and executed on a smart wearable device, wherein the smart wearable device comprises a display module and a touch-sensing structure, and the touch-sensing structure is disposed on one side of the display module, the method comprising:
detecting at least one data structure of the electronic data;
linking to at least one link instruction corresponding to the detected data structure;
enabling the detected data structure to be selected for inputting; and
executing the link instruction linked to the selected data structure according to an action received by the touch-sensing structure.

16. The method of claim 15, wherein the steps of detecting comprises:
analyzing a grammar of the electronic data;
comparing the grammar of the electronic data with a plurality of grammar rules pre-stored in the smart wearable device; and
detecting the data structure of at least one grammar from the electronic data corresponding to the grammar rules.

17. The method of claim 16, wherein the detected data structure corresponding to the grammar rules is linked to the link instruction.

18. The method of claim 15, wherein the steps of detecting comprises:
analyzing a string in the electronic data;
comparing the string in the electronic data with a plurality of predefined string patterns pre-stored in the smart wearable device; and
detecting the data structure of at least one string from the electronic data corresponding to the predefined string patterns.

19. The method of claim 15, further comprising:
marking the information of the detected data structure displayed on the display unit.

20. The method of claim 15, wherein the step of enabling comprises:
displaying contents of the link instruction on the display unit in a menu form.
